(19) United States
(12) Patent Application Publication
(10) Pub. No.: US 2023/0271337 A1
(43) Pub. Date: Aug. 31, 2023

(54) GRIPPER FOR THE TRANSPORTATION OF AN OPHTHALMIC LENS

(71) Applicant: Alcon Inc., Fribourg (CH)

(72) Inventors: Felix Brinckmann, Roßdorf (DE); Sergej Riskin, Elsenfeld (DE); Nils Schweizer, Bad König (DE); Johannes Neumann, Obernburg am Main (DE)

(21) Appl. No.: 18/173,857

(22) Filed: Feb. 24, 2023

Related U.S. Application Data
(60) Provisional application No. 63/268,623, filed on Feb. 28, 2022.

(51) Int. Cl. B25J 15/06; B25J 17/02; B25J 15/04

(52) U.S. Cl. CPC B25J 15/0683; B25J 17/02; B25J 15/0658; B25J 15/04

(57) ABSTRACT

A gripper for the transportation of an ophthalmic lens comprises:
a gripper shaft having a longitudinal shaft axis and a fluid channel extending through the gripper shaft;
a connector at the proximal end of the gripper shaft for connecting a flexible supply tube and the proximal end of the gripper shaft;
a support movably accommodating the gripper shaft;
a spring mounted between the support and the gripper shaft, the spring biasing the gripper shaft distally away from the support; and
a gripper head attached to the gripper shaft at a distal end portion thereof, the gripper head having a further fluid channel extending therethrough, the gripper head further having a suction opening which is centrally arranged in a distal end surface of the gripper head, the suction opening being in fluid communication with the fluid channel of the gripper shaft through further fluid channel.

The gripper head is configured to be pivotable about a pivot portion of the gripper head.

### TECHNICAL FIELD

The present invention generally relates to the field of ophthalmic lenses, for example contact lenses such as soft contact lenses. More particularly, the invention relates to a gripper for the transportation of such lenses.

### BACKGROUND ART

In the automated manufacture of ophthalmic lenses, in particular contact lenses such as soft contact lenses, the lenses must be transported between different stations and/or modules of a production line. In many instances, grippers are used for this transportation. To effect transportation, the gripper picks up a lens at a start location and makes the lens adhere to the gripper by sucking the lens against the gripper with the aid of vacuum. The gripper then moves towards the destination location with the lens adhered to the gripper, and subsequently releases the lens from the gripper at the destination location, typically by ‘blowing the lens off the gripper’ with the aid of overpressure.

For example, in one embodiment of the automated manufacture of soft contact lenses, the lenses that have been extracted and treated in a treatment module comprising various chemical treatment baths (including water baths) must be transferred/transported to inspection cuvettes of a subsequent inspection module in which the contact lenses are optically inspected. This transfer/transportation of the contact lenses occurs at a transfer station where the contact lenses need to be transferred/transported from baskets of an uppermost treatment carrier of a stack of treatment carriers (in which the lenses are carried through the various treatment baths) into inspection cuvettes of an inspection module. Each of the baskets contains one lens that is to be transferred/transported into a corresponding inspection cuvette. Treatment carriers suitable for this purpose are known, for example, from WO 2018/185630. Typically, a plurality of lenses is simultaneously transferred from a plurality of baskets into a corresponding plurality of inspection cuvettes—one lens from one basket into one inspection cuvette, respectively—with the aid of a corresponding plurality of grippers.

For that purpose, at the transfer station a corresponding plurality of grippers is arranged above the baskets of the treatment carriers such that each individual longitudinal axis of each of the grippers is arranged to coincide with each individual longitudinal axis of the respective basket. The grippers are stiff rigid grippers having openings in a convex distal end face of the gripper. For picking the lenses up from the baskets, the grippers are lowered to a predetermined axial position (z-position) which is determined such that in the lowermost position (lens pick-up position) the grippers either touch the concave back surfaces of the lenses to be picked up, or are arranged a very small distance above the lenses so that in either case the application of vacuum through the openings makes the lenses adhere against the convex end face of the gripper.

However, there are a number of problems that may arise in the afore-described process of picking the lenses up from the baskets of the treatment carriers with the aid of the afore-described grippers and transporting them to the inspection cuvettes.

First of all, the grippers are stiff rigid grippers. This may be disadvantageous as not all of the treatment carriers are perfectly even and therefore do not perfectly extend in a horizontal plane (x-y-plane) perpendicular to the axis of movement of the grippers (z-axis). For example, the treatment carriers may be very slightly curved (like a shallow dish) rather than being perfectly plane. As a consequence, the predetermined lowermost axial position of the grippers (lens pick-up position) may lead to the scenario that the convex distal end of one gripper associated with one of the basket of the treatment carrier touches the concave back surface of the lens contained in this basket while the convex distal end of another gripper associated to another basket of the same treatment carrier is arranged a short distance above the concave back surface of the lens and upon applying suction to the gripper may even fail to pick the lens up from the basket and make it adhere to the convex distal end of the gripper to perform the transfer.

Another problem related with the stiff rigid grippers is that the longitudinal axis of individual ones of the grippers for simultaneously picking the lenses up from the baskets of the treatment carrier may not perfectly coincide with the longitudinal axis of the associated basket, but may be slightly displaced laterally. Thus, when the gripper reaches the lowermost position (lens pick-up position) the gripper may be slightly displaced laterally. This may result in the gripper not being able to pick the lens at its center, which in turn may result in that the gripper may either not pick the lens up at all, or even worse the gripper may damage the lens which results in a reduced yield. In case the lens is actually picked up by the gripper, it may also occur that the lens is getting inverted due to the lens adhering to the basket, for example through water adhering to the lens and/or the basket.

Similar problems may occur when a lens is immersed in a liquid (e.g. in a cuvette) and needs to be picked up and transferred to a subsequent station or module (e.g. for being placed into a primary packaging shell).

It is therefore an object to suggest a gripper which overcomes the afore-mentioned disadvantages.

### SUMMARY OF THE INVENTION

In accordance with the present invention, these and other objects are met by a gripper as it is specified by the features of the independent claims. Advantageous aspects of the gripper according to the invention are the subject of the dependent claims.

As used in the specification including the appended claims, the singular forms “a”, “an”, and “the” include the plural, unless the context explicitly dictates otherwise. When using the term “about” with reference to a particular numerical value or a range of values, this is to be understood in the sense that the particular numerical value referred to in connection with the “about” is included and explicitly disclosed, unless the context clearly dictates otherwise. For example, if a range of “about” numerical value A to “about” numerical value B is disclosed, this is to be understood to include and explicitly disclose a range of numerical value A to numerical value B. Also, whenever features are combined with the term “or”, the term “or” is to be understood to also include “and” unless it is evident from the specification that the term “or” must be understood as being exclusive.

According to the invention, a gripper for the transportation of an ophthalmic lens is suggested. The gripper comprises:
a gripper shaft having a longitudinal shaft axis and a fluid channel extending through the gripper shaft in the direction of the longitudinal shaft axis;
a connector arranged at the proximal end of the gripper shaft for connecting a flexible supply tube and the proximal end of the gripper shaft such that the flexible supply tube is in fluid communication with the fluid channel of the gripper shaft in a fluid-tight manner, for the supply of vacuum or overpressure to the fluid channel;
a support movably accommodating the gripper shaft in a direction of the longitudinal shaft axis;
a spring mounted between the support and the gripper shaft, the spring biasing the gripper shaft distally away from the support in the direction of the longitudinal shaft axis; and
a gripper head attached to the gripper shaft at a distal end portion of the gripper shaft, the gripper head having a further fluid channel extending through the gripper head along a longitudinal head axis coincident with the longitudinal shaft axis, the gripper head further having a suction opening which is centrally arranged in a distal end surface of the gripper head at a distal end of the further fluid channel, the suction opening being in fluid communication with the fluid channel of the gripper shaft by means of the further fluid channel.

The gripper head is configured to be pivotable about a pivot portion of the gripper head.

According to one aspect of the gripper according to the invention, the gripper head may further comprise a plurality of recessed channels formed in the distal end surface of the gripper head. The recessed channels are connected to the centrally arranged suction opening and extend in a direction outwardly away from the centrally arranged suction opening.

According to a further aspect of the gripper according to the invention, the gripper head may have a gripping portion arranged at the distal end of the gripper head and a first conically shaped portion tapering from a largest diameter of the gripping portion towards the pivot portion which is cylindrical and has the smallest diameter of the gripper head. The cylindrical pivot portion is arranged proximal to the first conically shaped portion.

According to still a further aspect of the gripper according to the invention, the gripper head further may have a second conically shaped portion widening from a proximal end of the cylindrical pivot portion to a cylindrical mounting portion of the gripper head having a diameter larger than the diameter of the cylindrical pivot portion. The cylindrical mounting portion is arranged at the proximal end of the second conically shaped portion of the gripper head.

According to yet a further aspect of the gripper according to the invention, the largest diameter of the gripping portion may be in the range of 8 mm to 12 mm (millimeters). The first conically shaped portion may have an axial length in the range of 2 mm to 5 mm, and the pivot portion may have a diameter in the range of 3 mm to 6 mm and an axial length in the range of 1 mm to 4 mm. The second conically shaped portion may have an axial length in the range of 1.5 mm to 3 mm, and the diameter of the mounting portion may be in the range of 6 mm to 9 mm.

According to an alternative aspect of the gripper according to the invention, the largest diameter of the gripping portion may be in the range of 12 mm to 17 mm (millimeters). The first conically shaped portion may have an axial length in the range of 2 mm to 4 mm. The pivot portion may have a diameter in the range of 5 mm to 7 mm and an axial length in the range of 1 mm to 4 mm. The second conically shaped portion may have an axial length in the range of 1 mm to 3 mm, and the diameter of the mounting portion may be in the range of 6 mm to 9 mm.

According to still a further aspect of the gripper according to the invention, the gripper further may comprise a plug attached to the distal end of the gripper shaft, with the gripper head releasably mounted to the plug. The plug comprises a plug channel extending through the plug along a longitudinal plug axis coincident with the longitudinal shaft axis and with the longitudinal head axis. The plug channel is in fluid communication both with the fluid channel of the gripper shaft and with the further fluid channel extending through the gripper head.

According to yet a further aspect of the gripper according to the invention, the gripper head is made of an elastic material having a hardness Shore A in the range of 30 to 90 at room temperature, in particular silicone rubber, natural rubber or fluorinated rubber.

According to a further aspect of the gripper according to the invention, the connector comprises
a set sleeve resting on the support and threadingly accommodating a proximal end portion of the gripper shaft at a distal end of the set sleeve;
a fitting sleeve arranged in the set sleeve proximal to the proximal end portion of the gripper shaft, the fitting sleeve having a sleeve channel extending through the fitting sleeve and being bounded by a sleeve channel wall, the flexible supply tube extending through the sleeve channel and being fittingly connected to the sleeve channel wall in a fluid-tight manner, with a distal end portion of the flexible supply tube extending beyond a distal end of the fitting sleeve; and
a locking screw threadingly received in a proximal end portion of the set sleeve proximal to the fitting sleeve, the locking screw having a screw channel extending therethrough, with the flexible supply tube extending through the screw channel and further through the sleeve channel of the fitting sleeve, the locking screw further having a distal abutment surface abutting against a proximal abutment surface of the fitting sleeve pressing the fitting sleeve towards a proximal end face of the gripper shaft, thus clamping the distal end portion of the flexible supply tube that extends beyond the distal end of the fitting sleeve between a distal abutment surface of the fitting sleeve and the proximal end face of the gripper shaft, thereby establishing a fluid-tight fluid communication (against the exterior) between the flexible supply tube and the fluid channel of the gripper shaft.

The gripper according to the invention offers a number of advantages. First of all, in the scenario described further above in which a treatment carrier is not perfectly even (e.g. is shaped like a shallow dish) and therefore does not perfectly extend in a horizontal plane (x-y-plane) perpendicular to the axis of movement of the gripper (z-axis), the predetermined z-position to which the individual gripper (or the plurality of grippers) is moved is chosen such that the (typically convex) distal end surface of the gripper head touches the concave back surface of the lens contained in the respective basket in any event. This means, that in case a plurality of grippers is arranged in a manner corresponding to the arrangement of the baskets of the carrier, all individual grippers of the plurality of grippers may be simultaneously moved to the predetermined z-position. On the way to the predetermined z-position, this may lead to a temporary scenario in which the distal end surface of the gripper head of individual ones of the plurality of grippers already touches the back surface of the lens in the corresponding basket of the treatment carrier while the distal end surface of the gripper head of other grippers of the said plurality of grippers does not yet touch the back surface of the lens in the corresponding basket. In such instance, for those grippers for which the respective gripper head already touches the concave back surface of the lens, during further movement of the grippers towards the predetermined z-position the spring mounted between the support and the gripper shaft is compressed to avoid damaging of the lens (the spring rate of the spring being appropriately selected to avoid too high a force being applied to the lens) while maintaining the contact between the distal surface of the gripper head and the concave back surface of the lens. Prior to reaching the predetermined z-position, the distal end surface of each individual gripper of the plurality of grippers touches the concave back surface of the lens contained in the corresponding basket of the treatment carrier. At the time of reaching the predetermined z-position, the spring of each individual gripper is compressed to a greater or lesser extent. Thus, it is ensured that there is good contact between the distal end surface of each individual gripper and the concave back surface of the lens contained in the corresponding basket at the time the gripper reaches the predetermined z-position, while at the same time damaging of the lens is avoided. Regardless of whether only one or a plurality of grippers is used, this allows for setting the z-position within a certain range that makes sure that there is good contact between the distal end surface of the gripper and the lens while at the same time reliably avoiding damaging of the lens. This eliminates or at least greatly reduces the number of failed lens transfers from the baskets of the treatment carriers to the inspection cuvettes caused by a failed pick-up of the lens, and thus increases the production yield.

Also, the gripper according to the invention is advantageous in situations in which the longitudinal axis of individual ones of the plurality of grippers for simultaneously picking the lenses up from the baskets of the treatment carrier is slightly displaced laterally relative to the longitudinal axis of the associated basket of the treatment carrier. During movement of such laterally displaced gripper towards the predetermined z-position, this results in that one or more portions of the concave back surface of the lens are already in contact with the distal end surface of the gripper head of the (slightly laterally displaced) gripper while other portions of the concave back surface of the lens are not yet in contact with the distal end surface of the gripper head. During further movement of the gripper towards the predetermined z-position, this causes the gripper head to pivot about the pivot portion of the gripper head such that the distal end surface of the gripper head adapts to the concave back surface of the lens, thus making sure that there is good contact between the distal end surface of the gripper head and the concave back surface of the lens. Upon reaching the predetermined z-position, there is good contact between the distal end surface of the gripper head and the concave back surface of the lens for each individual gripper of the plurality of grippers, so that the lenses contained in the respective baskets of the treatment carrier can all be reliably picked-up upon the application of vacuum.

Also, the gripper according to the invention is advantageous in that the number of inverted lenses adhering to the gripper can be eliminated or at least greatly reduced due to the good contact between the distal end surface of the gripper head and the concave back surface of the lens. This may help eliminating an inverted lens detection station and a lens inversion station in an inspection module of the production line which is otherwise needed to detect and re-inverted an inverted lens prior to placing it into a packaging shell.

In case a plurality of recessed channels is formed in the distal end surface of the gripper head which are connected to the centrally arranged suction opening and extend in a direction outwardly away from the centrally arranged suction opening, this is further advantageous with respect to the gripping action (lens pick-up). When the distal end surface of the gripper head contacts the concave back surface of the lens, the vacuum applied through the centrally arranged suction opening is further guided along the recessed channels to improve the gripping action. Due the channels being recessed in the distal end surface of the gripper head, they cannot get blocked by the lens adhering to the distal end surface. By way of example, these channels may extend radially outwardly from the centrally arranged suction opening in a star-like pattern.

The gripper head may have a gripping portion arranged at the distal end of the gripper head and a first conically shaped portion tapering from a largest diameter of the gripping portion towards the pivot portion which may be cylindrical and has the smallest diameter of the gripper head. The cylindrical pivot portion may be arranged proximal to the first conically shaped portion, and the pivot point is arranged in the said cylindrical pivot portion. Thus, when the longitudinal axis of the gripper is slightly displaced laterally relative to the longitudinal axis of the respective basket of the treatment carrier in which the lens is contained, the gripper head (or to be more precise: the gripping portion of the gripper head) pivots about the pivot point located in the cylindrical pivot portion when the distal end surface of the gripping portion gripper head contacts the lens. The gripper head may further have a second conically shaped portion that widens from a proximal end of the cylindrical pivot portion to a cylindrical mounting portion of the gripper head. This cylindrical mounting portion has a diameter larger than that of the cylindrical pivot portion. The cylindrical mounting portion may be mounted to the gripper shaft, for example with the aid of a plug which is attached to the distal end of the gripper shaft, as will be explained in more detail below. Such a gripper head is easy from a constructional point of view, it is easy to manufacture, and it can be easily attached to and detached from the gripper shaft so that it can be easily replaced (for example, the gripper head can be mounted to and unmounted from the plug attached to the distal end of the gripper shaft).

Depending on whether the lens is to be picked up from a basket of a treatment carrier which is arranged in an air environment or in a liquid environment (e.g. when the lens is to be picked up from a cuvette filled with a liquid) the dimensions of the afore-mentioned portions of the gripper head may be different.

When a soft contact lens is to be picked up from a basket in an air environment, the largest diameter of the gripping portion may be in the range of 8 mm to 12 mm, and its axial length may be in the range of 2 mm to 4 mm. The first conically shaped portion that tapers from this largest diameter of the gripping portion to the cylindrical pivot portion may extend over an axial length in the range of 2 mm to 5 mm. The cylindrical pivot portion may have an axial length that is in the range of 1 mm to 4 mm. The second conically shaped portion that widens from the proximal end of the cylindrical pivot portion to the cylindrical mounting portion may have an axial length in the range of 1.5 mm to 3 mm, and the cylindrical mounting portion may have an axial length of 2 mm to 5 mm. Soft contact lenses typically have a diameter of 14 mm up to 14.5 mm or even 15 mm. The largest diameter of the gripping portion is smaller than this diameter, so that the edge and a radial outer portion of the lens extend radially beyond the radial outer boundary of the gripping portion of the gripper head. After the concave back surface of the lens is sucked against the distal end surface of the gripper head to adhere to the distal end surface, rapidly moving the gripper in the z-direction away from the basket of the treatment carrier does not cause those portions of the lens that extend beyond the outer boundary of the gripping portion of the gripper head to flip and thus to possibly invert the lens. Thus, the largest diameter of the gripping portion can be chosen smaller than the diameter of the lens.

When a soft contact lens is to be picked up in a liquid environment, e.g. from a cuvette in which the lens is immersed in a liquid such as water or saline, the largest diameter of the gripping portion may be in the range of 12 mm to 17 mm, and its axial length may be in the range of 2 mmm to 5 mm. The first conically shaped portion that tapers from this largest diameter of the gripping portion to the cylindrical pivot portion extends over an axial length in the range of 2 mm to 4 mm. The cylindrical pivot portion may have an axial length that is in the range of 1 mm to 4 mm. The second conically shaped portion that widens from the proximal end of the cylindrical pivot portion to the cylindrical mounting portion may have an axial length in the range of 1 mm to 3 mm, and the cylindrical mounting portion may have an axial length of 2 mm to 5 mm. Due to soft contact lenses typically having a diameter of 14 mm up to 14.5 mm or even 15 mm (see above), the largest diameter of the gripper is chosen such that more or less the entire concave back surface of the lens adheres to the distal end surface of the gripper. Preferably, the edge of the lens does not extend beyond the radial outer boundary of the gripping portion of the gripper head, although it may be tolerable that a small portion of the lens (close to the lens edge) may extend beyond the radial outer boundary of the gripping portion. As no (or only very small) portions of the lens extend beyond the radial outer boundary of the gripping portion, once the concave back surface of the lens is sucked against the distal end surface of the gripper head to adhere to the distal end surface, rapidly moving the gripper in the z-direction out of the liquid environment (e.g. out of the liquid contained in the cuvette) does not cause the lens to flip (due to viscosity of the liquid), as there are no (or only very small) portions of the lens that extend beyond the outer boundary of the gripping portion of the gripper head. To achieve this, the largest diameter of the gripping portion is preferably chosen to be larger than or as large as the diameter of the lens (with diameters which are only a very little smaller than that of the lens being tolerable, too).

As already mentioned, a plug may be attached to the distal end of the gripper shaft (e.g. the plug may be mounted to the distal end of the shaft by a threaded connection). The gripper head may be releasably mounted to the plug. The plug comprises a plug channel that extends through the plug along a longitudinal plug axis (coincident with the longitudinal shaft axis). As the plug channel is in fluid communication with the fluid channel extending through the gripper shaft, a continuous fluid channel is formed extending through both the gripper shaft and the plug. The plug channel is also in fluid communication with the further fluid channel that extends through the gripper head along the longitudinal head axis which is also coincident with the longitudinal shaft axis. As a result, a continuous channel is formed through the gripper shaft, the plug, and the gripper head, so that vacuum supplied to the proximal end of the gripper is supplied through the so formed continuous channel down to the suction opening centrally arranged in the distal end surface of the gripper head.

A suitable gripper head may be made from an elastic material having a hardness Shore A in the range of 30 to 90 at room temperature. For example, the elastic material may be silicone rubber, natural rubber or fluorinated rubber.

A specific advantageous embodiment of the gripper according to the invention comprises a set sleeve that rests on the support and that threadingly accommodates a proximal end portion of the gripper shaft. This embodiment further comprises a fitting sleeve arranged in the set sleeve proximal to the proximal end portion of the gripper shaft. The fitting sleeve has a sleeve channel that extends through the fitting sleeve and is bounded by a sleeve channel wall. The flexible supply tube (through which the vacuum is supplied) extends through this sleeve channel and is fittingly connected to the sleeve channel wall in a fluid-tight manner. The term ‘fittingly connected in a fluid-tight manner’ is to be understood in a sense that there is no bypass channel between an outer surface of the wall of the supply tube and the sleeve channel wall through which fluid may pass. For example, the supply tube may be connected to the sleeve channel wall by means of a press-fit. The distal end portion of the flexible tube extends beyond a distal end of the fitting sleeve. A locking screw is threadingly received in a proximal end portion of the set sleeve. This locking screw has a screw channel extending therethrough, and the flexible supply tube extends through this screw channel and further through the sleeve channel of the fitting sleeve. The locking screw further has distal abutment surface that abuts against a proximal abutment surface of the fitting sleeve. The locking screw is screwed into the proximal end of the set sleeve and presses the distal end of the fitting sleeve towards the proximal end of the gripper shaft. Thereby, the end of the supply tube that extends beyond the distal end of the fitting sleeve is flared radially outwardly and clamped in a fluid-tight manner between the distal end of the fitting sleeve and the proximal end of the gripper shaft. A fluid-tight fluid communication/connection is thus established between the flexible supply tube and the fluid channel that extends through the gripper shaft. And this fluid-tight communication/connection is then continued down to the centrally arranged suction opening in the distal end surface of the gripper head and further through the outwardly extending recessed channels, if present, in the distal end surface of the gripper head.

This is a particularly practical embodiment how the gripper according to the invention may be embodied for clean room production applications, with no undercuts being present in the fluidic path to avoid any microbiological contamination. At the same time, it is comparatively simple from a constructional point of view so that it is easy to assemble. The extent to which the proximal end portion of the gripper shaft is threaded into the set sleeve determines how much the spring that is mounted between the support and the gripper shaft is compressed, and thus allows to set the z-position of the distal end surface of the gripper head attached to the distal end portion of the gripper shaft to a predetermined z-position. With the aid of the fitting sleeve having the supply tube extending through the sleeve channel in a fluid-tight manner to project beyond the distal end of the fitting sleeve, and further with the aid of the locking screw being threadingly received in the proximal end of the set sleeve, it is possible to establish a fluid tight communication/connection between the flexible supply tube and the fluid channel extending through the gripper shaft. Vacuum for picking the lens up and making it adhere to the distal end surface of the gripper head (or overpressure for releasing the lens therefrom) may then be supplied through the flexible supply tube and is guided in a fluid-tight manner down to the centrally arranged suction opening in the distal end surface of the gripper head. The fluid-tight communication between the is achieved by screwing the locking screw into the set sleeve, thus urging the fitting sleeve towards the proximal end face of the gripper shaft. The distal end of the flexible supply tube that projects beyond the distal end of the fitting sleeve is thereby flared radially outwardly and clamped in a fluid-tight manner between the distal end of the fitting sleeve and the proximal end of the gripper shaft.

### BRIEF DESCRIPTIONS OF THE DRAWINGS

Further advantageous aspects of the gripper according to the invention will become apparent from the following description of embodiments with the aid of the schematic drawings, in which:

FIG. 1 shows a perspective view of portion of a treatment carrier comprising baskets for accommodating contact lenses and carrying them through one or more liquid treatment baths;

FIG. 2 shows a sectional view of an embodiment of the gripper according to the invention arranged above an individual basket of the treatment carrier containing a contact lens;

FIG. 3 shows an enlarged view of the detail III of FIG. 2;

FIG. 4 shows a side view of a plurality of grippers according to the invention at the time of picking up a corresponding plurality of contact lenses from the respective baskets of the treatment carrier;

FIG. 5 shows an enlarged view of the detail V of FIG. 4;

FIG. 6 shows an enlarged view of detail VI of FIG. 2;

FIGS. 7-10 show different views of a first embodiment of the gripper head of the gripper according to the instant invention; and

FIGS. 11-14 show different views of a second embodiment of the gripper head of the gripper according to the instant invention.

### DETAILED DESCRIPTIONS

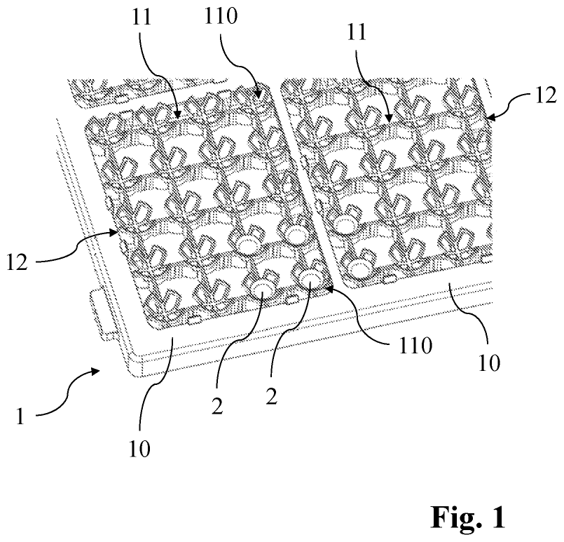

In FIG. 1 a portion of a treatment carrier 1 known in the art is shown. Such treatment carrier 1 is disclosed, for example, in WO 2018/185630. Treatment carrier 1 comprises a frame 10, e.g. made of aluminum, stainless steel or a suitable plastic material, as well as carrier inserts 11 clicked into rectangularly shaped compartments 12, one carrier insert 11 into each compartment 12. In the embodiment shown in FIG. 1, one carrier insert 11 comprises twenty baskets 110 arranged in five rows and four columns. For illustration purposes, some of the baskets 110 contain a contact lens 2. In practice, for efficiency reasons, typically each basket 110 contains a contact lens 2, and a plurality of treatment carriers 1 may be arranged one above the other to form a stack which is transported through the one or more liquid treatment baths.

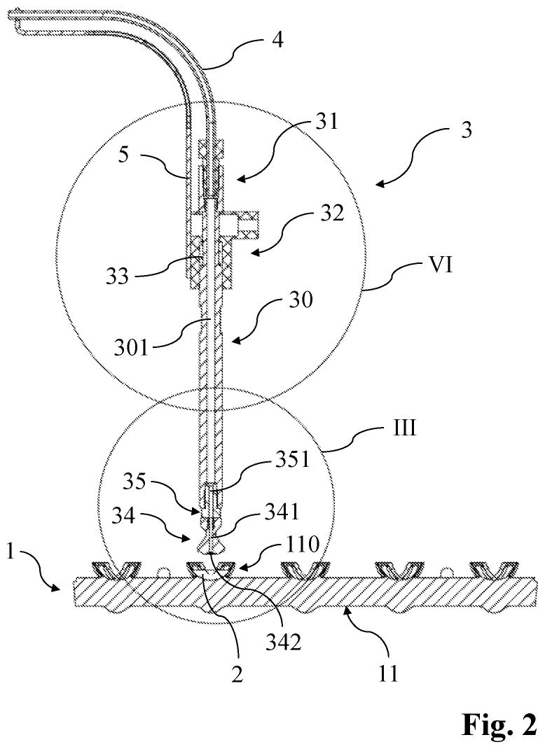

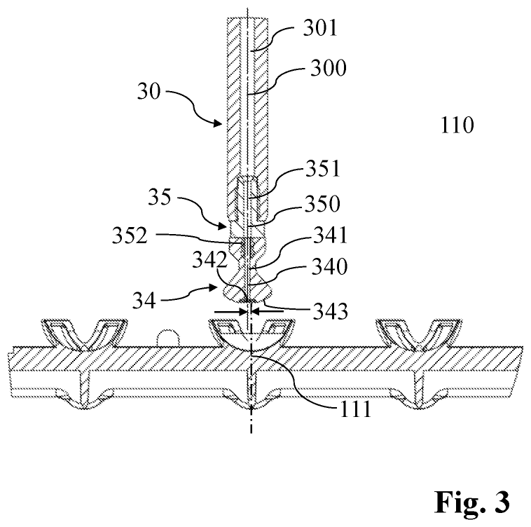

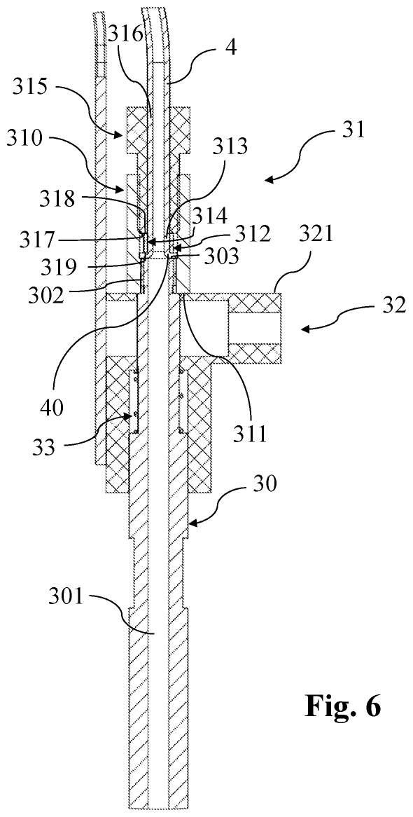

FIG. 2 shows a sectional view of an embodiment of the gripper 3 according to the invention, arranged above an individual basket 110 of the carrier insert 11 of treatment carrier 1. Gripper 3 is shown in a position prior to picking up the contact lens 2 contained in basket 110. The purpose of FIG. 2 is to show the overall structure and arrangement of the gripper 3 relative to the basket 110 of the treatment carrier 1 in which the contact lens 2 to be picked up is contained, while details of this embodiment will be discussed with the aid of FIG. 3 and FIG. 6 showing the details III and VI of FIG. 2.

Gripper 3 comprises a gripper shaft 30 having a longitudinal shaft axis 300 (see FIG. 3), and further comprises a fluid channel 301 extending through gripper shaft 30 in the direction of the longitudinal shaft axis 300. A connector 31 is arranged at the proximal end of gripper shaft 30. Connector 31 connects a flexible supply tube 4 with the fluid channel 301 of gripper shaft 30 in a fluid-tight manner such that they are in fluid communication with one another, for the supply of vacuum or overpressure to the fluid channel 301 of gripper shaft 30. Connector 31 will be described in more detail below.

Gripper 3 further comprises a support 32 movably accommodating the gripper shaft in a direction of the longitudinal shaft axis 300. Support 32 of gripper 3 may be fixedly mounted to a gripper system to which a plurality of individual grippers 3 may be mounted. A tube holder 5 may be provided to support and hold flexible supply tube 4 and to guide it to the gripper 3. A spring 33 is mounted between the support 32 and the gripper shaft 30, the spring 33 biasing the gripper shaft 30 distally away from the support 32.

A gripper head 34 is attached to the gripper shaft 30 at the distal end of the gripper shaft 30, and in this embodiment the gripper head 34 is attached to the gripper shaft 30 with the aid of a plug 35 that is threadingly received by the gripper shaft 30. Plug 35 has a longitudinal plug axis 350 (see FIG. 3) and a plug channel 351 extending through the plug 35 along the longitudinal plug axis 350. The longitudinal plug axis 350 coincides with the longitudinal shaft axis 300.

Gripper head 34 is made of a flexible material such as, for example, silicone rubber, natural rubber, or fluorinated rubber, and can be mounted to the plug 35 by pushing the gripper head 34 axially over a retaining structure 352 provided on an outer surface of the plug 35. Due to the flexibility of the material the gripper head 34 is made of, the gripper head 34 is securely attached to the plug 35 and can also be easily replaced. Gripper head 34 has a longitudinal head axis 340 and a fluid channel 341 that extends through the gripper head 34 along the longitudinal head axis 340. Longitudinal head axis 340 is coincident both with the longitudinal shaft axis 300 as well as with the longitudinal plug axis 350. The fluid channel 301 extending through gripper shaft 30, the plug channel 351 extending through the plug 35, and the fluid channel 341 extending through gripper head 34 are thus in fluid communication with one another. Gripper head 34 further comprises a suction opening 342 which is arranged centrally in a distal end surface 343 of gripper head 34. Thus, vacuum or overpressure supplied to the flexible supply tube 4 is guided through fluid channel 301 of gripper shaft 30, further through plug channel 351 of plug 35, and finally through fluid channel 341 of gripper head 34 down to the suction opening 342.

Detail III of FIG. 2 is shown in FIG. 3 in an enlarged view, and illustrates a problem that may occur in picking up the contact lens 2 from the basket 110 of treatment carrier 1. As can be seen in FIG. 3, the longitudinal head axis 340 of the gripper head (and this holds, too, for the longitudinal plug axis 350 and for the longitudinal shaft axis 300, as these are coincident) may be slightly displaced laterally relative to a central longitudinal axis 111 extending through the basket 110. Thus, as the gripper 3 is moved downwardly for picking the contact lens 2 up the gripper head 34 may contact the back surface of contact lens 2 slightly eccentrically which—when using a conventional gripper—may possibly result in the contact lens 2 not being picked up properly. The gripper 3 according to the invention is capable of compensating for such slight lateral displacement, as is explained further below.

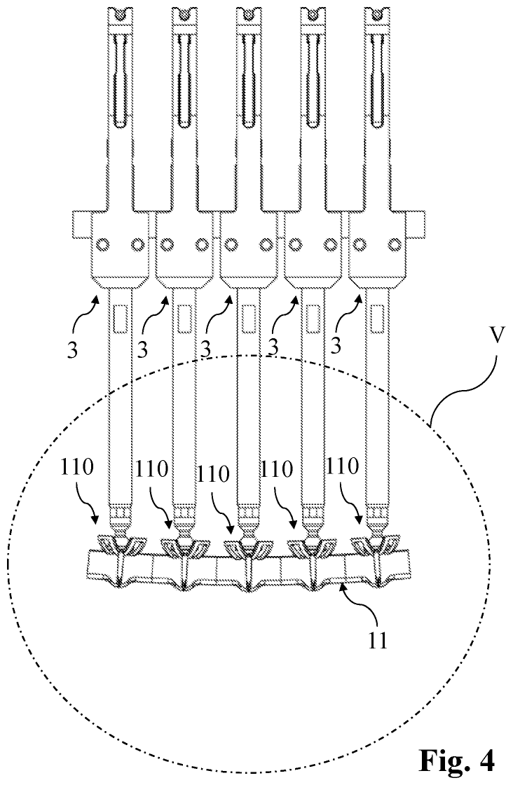

FIG. 4 shows a plurality of grippers 3 (by way of example five grippers 3) concurrently picking up a corresponding plurality of contact lenses 2 from the baskets 110. For example, the plurality of grippers 3 shown in FIG. 3 may concurrently pick up the contact lenses 2 contained in the baskets 110 of one column of the treatment carrier insert 11 of treatment carrier 1 shown in FIG. 1.

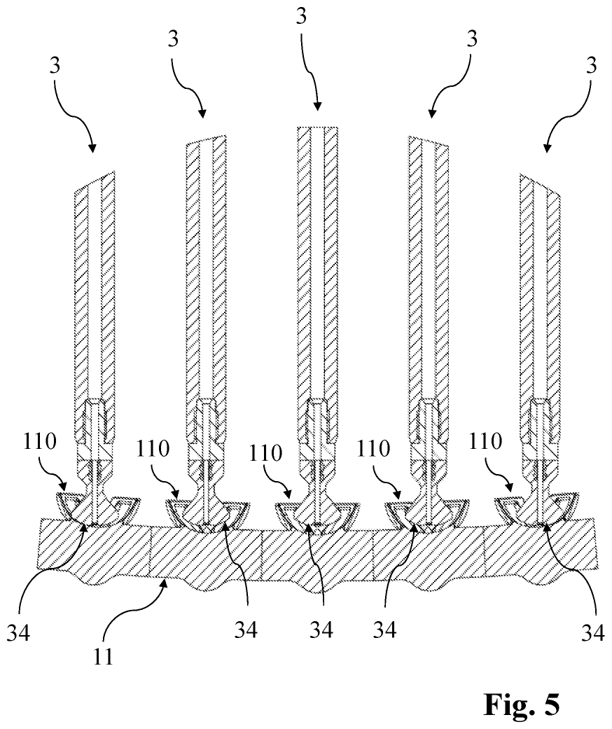

FIG. 5 shows the detail V of FIG. 5 for illustrating a further problem that may occur when conventional grippers are used (although grippers 3 according to the invention are shown in FIG. 5). This problem may come up as the treatment carrier inserts 11 comprising the baskets 110 may not be perfectly plane but may be shaped like a shallow dish. This is exaggeratedly shown in FIG. 5. While each of the gripper heads 34 is arranged at the same z-position, the outermost left gripper 3 and the outermost right gripper 3 contact the respective basket 110 (or a contact lens contained in the basket) while the second outermost left gripper 3 and the second outermost right gripper 3 as well as the central gripper 3 do not contact the respective basket 110 due to the shallow dish shape of the treatment carrier insert 11. Also, as can be seen in FIG. 5, the outermost left gripper 3 and the outermost right gripper 3 both contact the basket 110 eccentrically. With conventional rigid grippers this may lead to one or more contact lenses being improperly picked up or not being picked up at all. Or, in case the contact lenses adhere to the baskets 110 due to liquid adhering to the baskets 110, the contact lenses may become inverted while being picked up (i.e. the central portion of the contact lens may be sucked against the gripper surface while the radially outer portions of the contact lens may continue to adhere to the baskets 110, thus resulting in an inversion of the contact lens as the lens is picked up). The gripper 3 according to the invention is capable of avoiding such lens inversion, as is explained further below.

FIG. 6 shows the detail VI of FIG. 2 in an enlarged view. As can be seen there, connector 31 (see also FIG. 2) comprises a set sleeve 310. Set sleeve 310 threadingly accommodates a threaded proximal end portion 302 of gripper shaft 30 at a distal end of set sleeve 310. The distal end surface 311 of set sleeve 310 abuts against an upper surface 321 of support 32, so that the gripper shaft is secured against falling down. Spring 33 biases the gripper shaft 30 distally away from the support 32. Thus, with the aid of the set sleeve 310 it is possible to define the z-position of the distal end surface 343 of the gripper head 34 (see FIG. 3) relative to the support 32.

Connector 31 further comprises a fitting sleeve 312 which is arranged in the set sleeve 310 proximal to the proximal end portion 302 of gripper shaft 30. The fitting sleeve 312 has a sleeve channel 313 which is bounded by a sleeve channel wall 314 (inner wall of fitting sleeve 312). Flexible supply tube 4 extends through the sleeve channel 313 and is fittingly connected to sleeve channel wall 314 in a fluid-tight manner. For example, the outer diameter of the flexible tube 4 can be selected somewhat larger than the diameter of the sleeve channel 313. A distal end portion 40 of the flexible supply tube 4 extends beyond a distal end of the fitting sleeve 312.

Yet further, connector 31 comprises a locking screw 315 which is threadingly received in a proximal end portion of the set sleeve 310 proximal to fitting sleeve 312. Locking screw 315 has a screw channel 316 extending through the locking screw 315. The flexible supply tube 4 extends through the screw channel 316 and further through the sleeve channel 313 of fitting sleeve 312. Locking screw 315 has a distal abutment surface 317 and fitting sleeve 312 has a proximal abutment surface 318. Thus, by screwing locking screw 315 into set sleeve 310 until the distal abutment surface 317 of locking screw 315 abuts against the proximal abutment surface 318 of fitting sleeve 312, the fitting sleeve 312 is pressed towards a proximal end face 303 of gripper shaft 30. Thereby, the portion 40 of the flexible supply tube 4 that extends beyond the distal end of the fitting sleeve 312 is clamped between a distal abutment surface 319 of the fitting sleeve 312 and the proximal end face 303 of gripper shaft 30 and extends radially outwardly thus forming a fluid-tight seal. In this manner, a fluid-tight fluid communication is established between the flexible supply tube 4 and the fluid channel 301 of the gripper shaft 30.

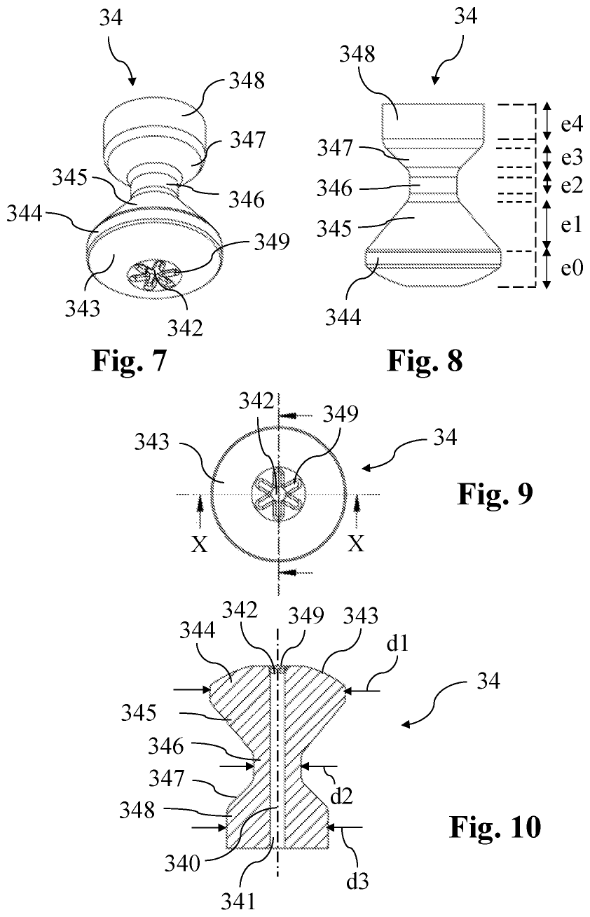

In FIGS. 7-10 a first embodiment of the gripper head 34 is shown. FIG. 7 shows a perspective view, FIG. 8 shows a side view, FIG. 9 shows a bottom view, and FIG. 10 shows a sectional view along lines X-X of FIG. 9. This first embodiment of the gripper head 34 is specifically embodied for picking a contact lens 2 up from a basket 110 of the carrier insert 11 of the treatment carrier 1 shown in FIG. 1. That is, the contact lens 2 is picked up from the basket 110 in an air (i.e. gaseous) environment. As can be seen, the gripper head 34 comprises the fluid channel 341 that extends through the gripper head 34 along the longitudinal head axis 340 (see FIG. 10, in which the gripper head 34 is shown upside down). Gripper head 34 comprises a gripping portion 344 arranged at the distal end of the gripper head 34. This gripping portion 344 includes the distal end surface 343 and the centrally arranged suction opening 342. A plurality of recessed channels 349 are formed in the distal end surface 343 of gripper head 34. These recessed channels 349 are connected to the centrally arranged suction opening 342 and extend in a direction outwardly away from the centrally arranged suction opening, as can be seen best in FIG. 7 and FIG. 9. Gripping portion 344 has a largest diameter d1 (indicated by the arrows in FIG. 10). A first conically shaped portion 345 then tapers from the largest diameter d1 towards a cylindrical pivot portion 346 having a diameter d2 which is the smallest diameter of the gripper head 34 (again indicated by the arrows in FIG. 10). Gripper head 34 further comprises a second conically shaped portion 347 that widens from a proximal end of the cylindrical pivot portion 346 to a cylindrical mounting portion 348 which has a diameter d3 (again indicated by the arrows in FIG. 10) larger than the diameter d2 of the cylindrical pivot portion 346.

By way of example, the largest diameter d1 of the gripping portion 344 may be in the range of 8 mm to 12 mm. By way of example, gripping portion 344 may have an axial length e0 (see FIG. 8) in the range of 2 mm to 4 mm. The first conically shaped portion 345 may have an axial length e1 (see FIG. 8) in the range of 2 mm to 5 mm. Pivot portion 346 may have a diameter d2 (see FIG. 10) in the range of 3 mm to 6 mm, and may have an axial length e2 (see FIG. 8) in the range of 1 mm to 4 mm. The second conically shaped portion 347 may have an axial length e3 (see FIG. 8) in the range of 1.5 mm to 3 mm, and the mounting portion 348 may have a diameter d3 (see FIG. 10) in the range of 6 mm to 9 mm as well as an axial length e4 (see FIG. 8) sufficient for it to be securely retained by the retaining structure 352 provided on the plug 35 (see FIG. 3). The axial length e4 may be in the range of 2 mm to 5 mm.

Operation of the gripper 3 comprising gripper head 34 shown in FIGS. 7-10 is now described with the aid of FIG. 5 and FIG. 6. For that purpose, assuming that the carrier insert 11 of the treatment carrier 1 is slightly shaped like a shallow dish, as is shown in FIG. 5 and makes the lens pick-up process more demanding. The five grippers 3 shown in FIG. 5 are mounted to the mounting member 5 of the gripper system such that the lowermost position of the distal end surface 343 of all grippers 3 is at the same level. The mounting members 5 to which the grippers 3 are mounted are now concurrently moved downwards to make the gripper heads 34 contact the back surfaces of the contact lenses 2 (the contact lenses 2 not being shown in FIG. 5) and pick the contact lenses 2 up from the baskets 110 by applying vacuum through the suction openings 342 and the recessed channels 349 (see FIG. 7 and FIG. 9). Due to the shallow dish-like shape of the carrier insert 11 (FIG. 5), the distal end surfaces 343 of the gripper heads 34 of the outermost left and the outermost right gripper 3 will first touch the back surfaces of the respective contact lens 2 (and since the contact lenses 2 are not shown in FIG. 5 this will be explained with the aid of the baskets 110 in the following). Even though there is (partial) contact between the distal end surfaces 343 of the gripper heads 34 of the outermost left and outermost right gripper 3 and the corresponding basket 110, there is no such contact yet between the distal end surfaces 343 of the gripper heads 34 of the three inner grippers 3 and the corresponding baskets 110, as ca be seen in FIG. 5. The concurrent movement of all mounting members 5 with the grippers 3 attached thereto is then continued in the downward direction (z-direction) to a predetermined z-position which is chosen such that distal end surface 343 of all grippers 3, including the gripper heads of the three innermost grippers 3 are also in contact with corresponding baskets 110. Due to the partial contact of the distal end surfaces 343 of the gripper heads 34 of the outermost left and the outermost right gripper 3 and the corresponding basket 110, during continued downward movement of the mounting members 5 in the z-direction, the gripper heads 34 of the outermost left gripper 3 and of the outermost right gripper 3 pivot about the pivot portion 346 (see FIG. 8). That is, the gripper head 34 of the outermost left gripper 3 pivots outwardly to make its distal end surface 343 match the shape of the inner surface of the outermost left basket 110 of the carrier insert 11 of treatment carrier 1. Similarly, the gripper head 34 of the outermost right gripper 3 pivots outwardly to make its distal end surface 343 match the shape of the outermost right basket 110 of the carrier insert 11 of treatment carrier 1. Further, during the continued downward movement the gripper shaft 30 of those grippers 3 of which the distal end surfaces 343 of the gripper heads are already in contact with the corresponding basket 110, the gripper shafts 30 move upwardly against the resilient force of the respective spring 33 which makes the gripper head 34 stay in the contact with the respective basket 110 (and in practice with the back surface of the contact lens 2 to be picked up). As can be seen in FIG. 6, when a gripper shaft 30 moves upwardly and compresses the spring, the connector 31 is also moved upwardly. This upward movement is a guided movement as the gripper shaft 30 is guided in the support 32. At the time of reaching the predetermined z-position to which the mounting members 5 are moved down, the distal end surfaces 343 of the gripper heads 34 of all five grippers 3 are in perfect contact with the corresponding basket 110 (or in practice with the back surface of the contact lens 2). At that time, vacuum is supplied through the supply tubes 4. This vacuum is then guided through the fluid channel 301 of the gripper shaft 30 (see FIG. 4), through the plug channel 351 of the plug 35, and through the fluid channel 341 of the gripper head 34 down to the suction opening 342 and outwards in the recessed channels 349. Thus, the contact lens 2 which is in contact with the distal end surface 343 and the gripper head 34 of the respective gripper is adhered to the distal end surface 343 of the gripper head 34 of the respective gripper 3 while at the same time this distal end surface perfectly matches the shape of the back surface of the contact lens 2. The supports 32 are then moved upwardly (i.e. in the z-direction but opposite to the direction of the downward movement for picking the contact lenses 2 up) with the vacuum continuing to be supplied through the supply tubes 4. Thus, the contact lenses 2 remain adhered to the distal end surfaces 343 of the gripper heads 34 of the grippers 3 and the grippers 3 can then be moved to a destination location. Byway of example, the destination location may be transfer station of a lens inspection module where inspection cuvettes are waiting to receive the contact lenses 2 transferred from the baskets 110 of the carrier insert 11 of the lens carrier 1. The contact lenses 2 can then be released from the grippers 3 at the destination location by either terminating the application of vacuum through the supply tubes 4 or by applying overpressure through the supply tubes 4. For example, at the destination location, the grippers 3 with the contact lenses 2 adhering to the distal end surfaces 343 of the gripper heads 34 can be moved downwardly into the inspection cuvettes, whereupon the supply of vacuum through the supply tubes may be terminated, or overpressure may be supplied through the supply tubes 4. Thus, the contact lenses 2 can be released from the grippers 3 (e.g. into the afore-described inspection cuvettes). As mentioned, this embodiment is an example of the application of the gripper 3 according to the invention in which the contact lens 2 is picked up from a basket 110 in an air environment, and may be placed into a receptacle in a liquid environment (cuvette filled with water or saline) or into a receptacle in an air environment (e.g. a packaging shell).

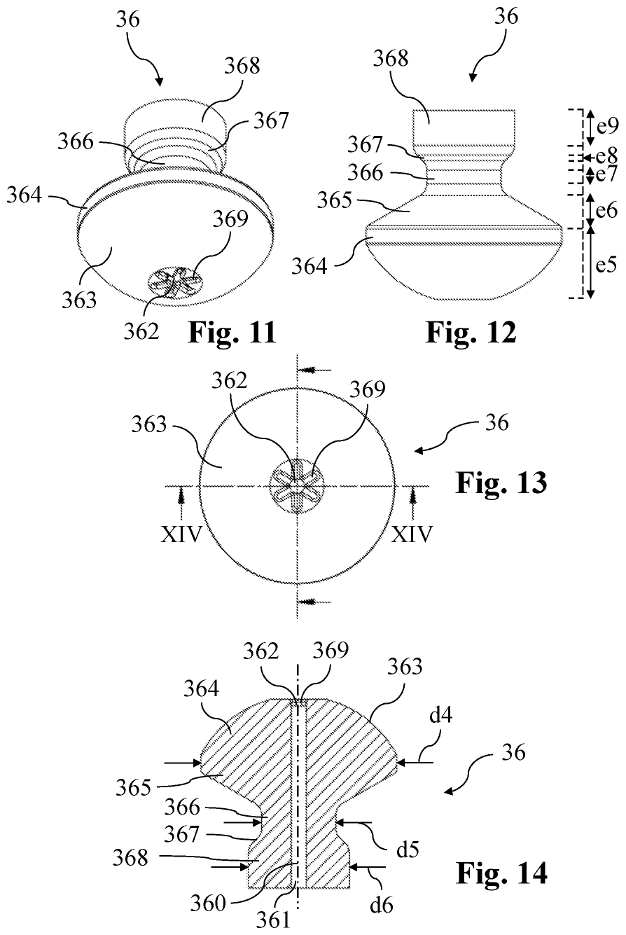

As already mentioned, the first embodiment of the gripper head shown in FIGS. 7-10 and described in detail above is specifically embodied for picking a contact lens up in an air environment, such as this is the case when picking a contact lens up from the basket 110 if the carrier insert 11 of the lens carrier 1 (this pick-up action occurring in an air environment). A second embodiment of the gripper head 36 is described in the following with the aid of FIGS. 11-14 showing a gripper head 36 that is particularly suitable for picking a contact lens up in a liquid environment. The remaining components of the gripper 3 remain the same and, therefore, they need not be described again. If the gripper head 34 described above were used in a liquid environment (this gripper head having a largest diameter of the gripping portion that is smaller than the diameter of the contact lens to be picked up), and a contact lens were picked up by the gripper in the liquid environment and the gripper subsequently moved upwards in the liquid environment, the quick upward movement of the gripper may cause the contact lens to get inverted due to the outer portions of the contact lens extending outwardly beyond the distal end surface of the gripper head, and further due to the viscosity of the liquid.

In FIGS. 11-14 a second embodiment of the gripper head 36 is shown. FIG. 11 shows a perspective view, FIG. 12 shows a side view, FIG. 13 shows a bottom view, and FIG. 14 shows a sectional view along lines XIV-XIV of FIG. 13. This second embodiment of the gripper head 36 is specifically embodied for picking a contact lens up in a liquid environment, e.g. from a conventional inspection cuvette of an inspection module in which the contact lens is inspected (rather than from a basket 110 of the carrier insert 11 of a treatment carrier 1). That is, the contact lens is picked up immersed in a liquid such as water or saline (rather than in a gaseous environment). As can be seen, the gripper head 36 comprises the fluid channel 361 that extends through the gripper head 36 along the longitudinal head axis 360 (see FIG. 10, in which the gripper head 36 is shown upside down). Gripper head 36 comprises a gripping portion 344 arranged at the distal end of the gripper head 34. This gripping portion 364 includes the distal end surface 363 and the centrally arranged suction opening 362. A plurality of recessed channels 369 are formed in the distal end surface 363 of gripper head 36. These recessed channels 369 are connected to the centrally arranged suction opening 362 and extend in a direction outwardly away from the centrally arranged suction opening, as can be seen best in FIG. 11 and FIG. 13. Gripping portion 364 has a largest diameter d4 (indicated by the arrows in FIG. 14). A first conically shaped portion 365 then tapers from the largest diameter d4 towards a cylindrical pivot portion 366 having a diameter d5 which is the smallest diameter of the gripper head 36 (again indicated by the arrows in FIG. 14). Gripper head 36 further comprises a second conically shaped portion 367 that widens from a proximal end of the cylindrical pivot portion 366 to a cylindrical mounting portion 368 which has a diameter d6 (again indicated by the arrows in FIG. 14) larger than the diameter d5 of the cylindrical pivot portion 366.

By way of example, the largest diameter d4 of the gripping portion 364 may be in the range of 12 mm to 17 mm. By way of example, gripping portion 364 may have an axial length e5 (see FIG. 12) in the range of 2 mm to 5 mm. The first conically shaped portion 365 may have an axial length e6 (see FIG. 12) in the range of 2 mm to 4 mm. Pivot portion 366 may have a diameter d5 (see FIG. 14) in the range of 5 mm to 7 mm, and may have an axial length e7 (see FIG. 12) in the range of 1 mm to 4 mm. The second conically shaped portion 367 may have an axial length e8 (see FIG. 12) in the range of 1 mm to 3 mm, and the mounting portion 368 may have a diameter d6 (see FIG. 14) in the range of 6 mm to 9 mm as well as an axial length e9 (see FIG. 8) sufficient for it to be securely retained by the retaining structure 352 provided on the plug 35 (see FIG. 3). The axial length e9 may be in the range of 2 mm to 5 mm.

As mentioned, one essential difference between the first embodiment of the gripper head 34 and the second embodiment of the gripper head 36 is that the largest diameter d4 of the gripping portion 364 of the second embodiment of the gripper head 36 is chosen such that it is larger than the typical diameter of soft contact lenses. As a consequence, when a contact lens is sucked against the distal end surface 363 of gripper head 36 in a liquid environment, the back surface of such contact lens is supported by the distal end surface over the entire diameter of the soft contact lens. Thus, when a soft contact lens is picked up by the gripper head 36 and thereafter adheres to the distal end surface 363 of gripper head 36, even a quick movement of the gripper 3 upward and out of the liquid does not involve the risk of the soft contact lens getting inverted as it is entirely supported by the distal end surface 363 of the gripper head 36 (no portions of the soft contact lens extending outwardly beyond the distal end surface 363).

As regards operation of the gripper 3 according to the invention having the second embodiment of the gripper head 36 attached to the plug 35 instead of the first embodiment of the gripper head 34, it is referred to the description given above, since the mode of operation is similar to the first embodiment. A detailed description of the mode of operation is therefore not repeated here.

While embodiments of the invention have been described with the aid of the drawings, the invention is not limited to these embodiments, but rather many changes and modifications can be made without departing from the technical teaching underlying the invention. Therefore, the scope of protection is not limited to the embodiments but is defined by the appended claims.

1. Gripper (3) for the transportation of an ophthalmic lens (2), the gripper (3) comprising
a gripper shaft (30) having a longitudinal shaft axis (300) and a fluid channel (301) extending through the gripper shaft (30) in the direction of the longitudinal shaft axis (300);
a connector (31) arranged at the proximal end of the gripper shaft (30) for connecting a flexible supply tube (4) and the proximal end of the gripper shaft (30) such that the flexible supply tube (4) is in fluid communication with the fluid channel (301) of the gripper shaft (30) in a fluid-tight manner, for the supply of vacuum or overpressure to the fluid channel (301);
a support (32) movably accommodating the gripper shaft (30) in a direction of the longitudinal shaft axis (300);
a spring (33) mounted between the support (32) and the gripper shaft (30), the spring (33) biasing the gripper shaft (30) distally away from the support (32) in the direction of the longitudinal shaft axis (300); and
a gripper head (34; 36) attached to the gripper shaft (30) at a distal end portion of the gripper shaft (30), the gripper head (34; 36) having a further fluid channel (341; 361) extending through the gripper head (34; 36) along a longitudinal head axis (340; 360) coincident with the longitudinal shaft axis (300), the gripper head (34; 36) further having a suction opening (342; 362) which is centrally arranged in a distal end surface (343; 363) of the gripper head (34; 36) at a distal end of the further fluid channel (341; 361), the suction opening (342; 362) being in fluid communication with the fluid channel (301) of the gripper shaft (30) by means of the further fluid channel (341; 361);
wherein the gripper head (34; 36) is configured to be pivotable about a pivot portion (346; 366) of the gripper head (34; 36).

2. Gripper according to claim 1, wherein the gripper head (34; 36) further comprises a plurality of recessed channels (349; 369) formed in the distal end surface (343; 363) of the gripper head (34; 36), the recessed channels (349; 369) being connected to the centrally arranged suction opening (342; 362) and extending in a direction outwardly away from the centrally arranged suction opening (342; 362).

3. Gripper according to claim 1, wherein the gripper head (34; 36) has a gripping portion (344; 364) arranged at the distal end of the gripper head (34; 36) and a first conically shaped portion (345; 365) tapering from a largest diameter (d1; d4) of the gripping portion (344; 364) towards the pivot portion (346; 366) which is cylindrical and has the smallest diameter (d2; d5) of the gripper head (34; 36), the cylindrical pivot portion (346; 366) being arranged proximal to the first conically shaped portion (345; 365).

4. Gripper according to claim 3, wherein the gripper head (34; 36) further has a second conically shaped portion (347; 367) widening from a proximal end of the cylindrical pivot portion (346; 366) to a cylindrical mounting portion (348; 368) of the gripper head (34; 36) having a diameter (d3; d6) larger than the diameter (d2; d5) of the cylindrical pivot portion (346; 366), the cylindrical mounting portion (348; 368) being arranged at the proximal end of the second conically shaped portion (347; 367) of the gripper head (34; 36).

5. Gripper according to claim 4, wherein the largest diameter (d1) of the gripping portion (344) is in the range of 8 mm to 12 mm, wherein the first conically shaped portion (345) has an axial length (e1) in the range of 2 mm to 5 mm, wherein the pivot portion (346) has a diameter (d2) in the range of 3 mm to 6 mm and an axial length (e2) in the range of 1 mm to 4 mm, wherein the second conically shaped portion (347) has an axial length (e3) in the range of 1.5 mm to 3 mm, and wherein the diameter (d3) of the mounting portion (368) is in the range of 6 mm to 9 mm.

6. Gripper according to claim 4, wherein the largest diameter (d4) of the gripping portion (364) is in the range of 12 mm to 17 mm, wherein the first conically shaped portion (365) has an axial length (e6) in the range of 2 mm to 4 mm, wherein the pivot portion (366) has a diameter (d5) in the range of 5 mm to 7 mm and an axial length (e7) in the range of 1 mm to 4 mm, wherein the second conically shaped portion (367) has an axial length (e8) in the range of 1 mm to 3 mm, and wherein the diameter (d6) of the mounting portion (368) is in the range of 6 mm to 9 mm.

7. Gripper according to claim 1, wherein the gripper further comprises a plug (35) attached to the distal end of the gripper shaft (30), with the gripper head (34; 36) releasably mounted to the plug (35), and wherein the plug (35) comprises a plug channel (351) extending through the plug (35) along a longitudinal plug axis (350) coincident with the longitudinal shaft axis (300) and with the longitudinal head axis (340; 360), the plug channel (351) being in fluid communication both with the fluid channel (301) of the gripper shaft (30) and with the further fluid channel (341; 361) extending through the gripper head (34; 36).

8. Gripper according to claim 1, wherein the gripper head (34; 36) is made of an elastic material having a hardness Shore A in the range of 30 to 90 at room temperature, in particular silicone rubber, natural rubber or fluorinated rubber.

9. Gripper according to claim 1, wherein the connector (31) comprises
a set sleeve (310) resting on the support (32) and threadingly accommodating a proximal end portion (302) of the gripper shaft (30) at a distal end of the set sleeve (310);
a fitting sleeve (312) arranged in the set sleeve (310) proximal to the proximal end portion (302) of the gripper shaft (30), the fitting sleeve (312) having a sleeve channel (313) extending through the fitting sleeve (312) and being bounded by a sleeve channel wall (314), the flexible supply tube (4) extending through the sleeve channel (313) and being fittingly connected to the sleeve channel wall (314) in a fluid-tight manner, with a distal end portion of the flexible supply tube (4) extending beyond a distal end of the fitting sleeve (312); and
a locking screw (315) threadingly received in a proximal end portion of the set sleeve (310′) proximal to the fitting sleeve (312), the locking screw (314) having a screw channel (316) extending therethrough, with the flexible supply tube (4) extending through the screw channel (316) and further through the sleeve channel (313) of the fitting sleeve (312), the locking screw (315) further having a distal abutment surface (317) abutting against a proximal abutment surface (318) of the fitting sleeve (312) pressing the fitting sleeve (312) towards a proximal end face (303) of the gripper shaft (30), thus clamping the distal end portion (40) of the flexible supply tube (4) that extends beyond the distal end of the fitting sleeve (312) between a distal abutment surface of the fitting sleeve (312) and the proximal end face (303) of the gripper shaft (30), thereby establishing a fluid-tight fluid communication between the flexible supply tube (4) and the fluid channel (301) of the gripper shaft (30).
